(19) United States
(12) Patent Application Publication
(10) Pub. No.: US 2012/0199680 A1
(43) Pub. Date: Aug. 9, 2012

(54) Bucket type jaw crusher

(76) Inventor: Toshiharu Ueda, Osaka (JP)

(21) Appl. No.: 12/931,550

(22) Filed: Feb. 3, 2011

(51) Int. Cl. B02C 1/02

(52) U.S. Cl. 241/267

(57) ABSTRACT

A bucket type jaw crusher JC includes stationary jaw teeth 20 fixed to the inner surface of a side plate 11 of a bucket 10, movable jaw teeth 30 opposed to the stationary jaw teeth 20 so as to form V shapes in combination with the stationary jaw teeth 20, a toggle plate 51 which supports a lower portion of the movable jaw teeth 30, an eccentric main shaft 41 which axially supports an upper portion of the movable jaw teeth 30, and a hydraulic motor 70 which drives and rotates the eccentric main shaft 41, and the bucket type jaw crusher JC is formed to be capable of crushing an object 100 to be crushed by the movable jaw teeth 30 which are driven to reciprocate by the hydraulic motor 70 via the eccentric main shaft 41 and the stationary jaw teeth 20. This bucket type jaw crusher JC includes a shaft joint mechanism 415J which joins a drive shaft 71 of the hydraulic motor 70 to an end portion of the eccentric main shaft 41, and the shaft joint mechanism 415J is provided with an allowable rupture portion 415c which ruptures earlier than a main body shaft portion 71m of the drive shaft 71 and the eccentric main shaft 41 when an abnormal overload is applied. The shaft joint mechanism 415J includes a sleeve 414 fitted and fixed inside an end portion of the eccentric main shaft 41, and a spline shaft 415 spline-engaged in a spline hole 414a of the sleeve 414 and a spline hole 71a formed in an end portion of the main body shaft portion 71m of the drive shaft 71, and the allowable rupture portion 415c is formed by a small-diameter portion of an annular groove formed on the spline shaft 415.

### BACKGROUND OF THE INVENTION

The present invention relates to a bucket type jaw crusher to be used for processing waste materials such as waste concrete, waste building materials, and waste pavement materials.

Conventionally, at a concrete building demolition site, steel frames and steel rods of a concrete building are cut, and for crushing waste concrete of the building into a transportable size, a crushing process is performed. For this crushing process, a bucket type jaw crusher removably attachable to the arm tip end of a stationary jaw crusher or a shovel excavator with excellent mobility is conventionally used.

FIG. 18 and FIG. 19 show a bucket type jaw crusher 500 disclosed in Japanese Laid-Open Patent Publication No. 2009-56423, and is described by using the same reference numerals for the same constituent elements as those of the bucket type jaw crushers of embodiments that will be described later.

The bucket type jaw crusher 500 includes stationary jaw teeth 20 fixed to the inner surface of the bottom portion of a bucket 10, movable jaw teeth 30 opposed to the stationary jaw teeth 20 so as to form V shapes in combination with the stationary jaw teeth 20, a toggle plate 51 supporting the lower portion of the movable jaw teeth 30, an eccentric main shaft 41 of an eccentric main shaft unit 40 which axially supports the upper portion of the movable jaw teeth 30, and a hydraulic motor 70 which drives and rotates the eccentric main shaft 41, and crushes an object to be crushed by the movable jaw teeth 30 which are driven to reciprocate by the hydraulic motor 70 via the eccentric main shaft 41 and the stationary jaw teeth 20.

In this bucket type jaw crusher 500, the hydraulic motor 70 is disposed on one side end portion of the eccentric main shaft 41, a flywheel 80 is disposed on the other side end portion, and at a middle portion, a counterweight 42, etc., are disposed, and accordingly, the eccentric main shaft 41 and its accessory members are unitized to make the entire apparatus compact. Therefore, the eccentric main shaft 41 and the shaft of hydraulic motor 70 are directly joined to each other by engaging a spline shaft portion 41c formed on a shaft end portion of the eccentric main shaft 41 into a spline hole formed at an end portion of the drive shaft of the hydraulic motor 70.

Further, on a tension rod 55a, gentle-arc-shaped washers 57a, 58a are provided on receiving seat portions of the tension rod 55a and the compression spring 56 so that increases and decreases in the inclination of the tension rod 55a can be followed. Crushing size adjusting plates 54 are fixed to the bucket side plate 16 via fixing plates by bolts inserted through bolt holes at both ends of the plurality of laminated crushing size adjusting plates 54.

In this type of jaw crusher 500, when the space between the stationary jaw teeth 20 and the movable jaw teeth 30 is clogged by an object to be crushed, the hydraulic motor 70 is reversely rotated to remove the clogging of the object to be crushed. However, to the eccentric main shaft 41, the flywheel 80 and the counterweight 42 are fitted integrally, so that the inertial force exerting on the eccentric main shaft unit 40 increases. Therefore, when switching the rotation of the hydraulic motor 70 from forward rotation to reverse rotation, a high shearing stress is applied to the joint portion between the hydraulic motor 70 and the eccentric main shaft 41 and may cause the spline shaft portion 41c of the eccentric main shaft 41 to be broken. When the spline shaft portion 41c is broken, the entirety of the unitized eccentric main shaft 41 needs to be replaced for repair. Also, when the hydraulic motor 70 is replaced by a large-sized hydraulic motor, if the size of the spline shaft portion 41c is different, the entire eccentric main shaft 41 must be replaced, and this increases the cost and may increase the time and effort required for disassembly and the downtime may lowers the work efficiency.

When the washers 57a, 58a of the tension rod 55a and the spring 56 have gentle arc shapes, the contact of the load to be applied to the washers 57a, 58a becomes line contact, so that the load bearing is deteriorated. The plurality of laminated adjusting plates 54 are fixed to the bucket side plate 16 via fixing plates by bolts inserted in bolt holes on both ends of the adjusting plates 54, so that in the case of size adjustment, long bolts and the plurality of adjusting plates 54 are handled concurrently, and it may take time to attach and remove the bolts and attach and remove the adjusting plates 54. In addition, after a bracket 13 on the bucket side is bolt-fastened to the arm tip end, the eccentric main shaft unit 40 is inserted from an openable and closable opening formed in the side plate portion 16, and accordingly, the assembling work is performed, so that there is a problem in the assembling workability.

An object of the present invention is to provide a bucket type jaw crusher which makes the repair work easy such as replacement of the hydraulic motor, a motor size change, and replacement of components of the shaft joint mechanism, etc., according to breakage and a change in crushing capacity, etc., of the hydraulic motor, and a bucket type jaw crusher which realizes crushing size adjustment in a short time by realizing quick and easy replacement of components such as the toggle plate.

### SUMMARY OF THE INVENTION

The present invention presents a bucket type jaw crusher of attachable to an arm of a hydraulic shovel, including stationary jaw teeth fixed to the inner surface of a bottom portion of a bucket, movable jaw teeth opposed to the stationary jaw teeth so as to form V shapes in combination with the stationary jaw teeth, a toggle plate supporting a lower portion of the movable jaw teeth, an eccentric main shaft axially supporting an upper portion of the movable jaw teeth, and a rotational driving means for driving and rotating the eccentric main shaft, and capable of crushing an object to be crushed by the movable jaw teeth that are driven to reciprocate by the rotational driving means via the eccentric main shaft and the stationary jaw teeth, wherein a shaft joint mechanism which joins a drive shaft of the rotational driving means to an end portion of the eccentric main shaft is provided, and the shaft joint mechanism is provided with an allowable rupture portion which ruptures earlier than a main body shaft portion of the drive shaft and the eccentric main shaft when an abnormal overload is applied.

In the bucket type jaw crusher of the present invention, when clogging of an object to be crushed occurs and the rotational driving means is switched from forward rotation to reverse rotation, if an abnormal overload is applied, the allowable rupture portion provided in the shaft joint mechanism ruptures earlier than the main body shaft portion of the drive shaft of the rotational driving means and the eccentric main shaft, so that without requiring replacement of the eccentric main shaft to which a flywheel and a counterweight are fitted integrally, repair can be performed by replacing components of the shaft joint mechanism, and the repair work can be made easy and the repair cost can be reduced.

Various configurations adoptable in an embodiment of the configuration of the present invention will be described in detail in embodiments, so that the description thereof shall be omitted herein.

### BRIEF DESCRIPTION OF THE DRAWINGS

FIG. 1 is a sectional view of a bucket type jaw crusher according to Embodiment 1 of the present invention.

FIG. 2 is a sectional view at line II-II of FIG. 1.

FIG. 3 is a sectional view of a shaft joint mechanism which joins a hydraulic motor and an eccentric main shaft.

FIG. 4 is a sectional view of a tension device.

FIG. 5 is a plan view of adjusting plates and a toggle plate.

FIG. 6 is a side view of an essential portion of a fixing plate.

FIG. 7 is a side view of a rocking member.

FIG. 8 is a perspective view of a stationary side load receiving section.

FIG. 9 is an explanatory view describing a method for fitting an eccentric main shaft unit of the bucket type jaw crusher.

FIG. 10 is a view showing an eccentric main shaft unit.

FIG. 11 is a view showing a state where the main shaft receiving portion and a main shaft receiving portion are disassembled.

FIG. 12 is an explanatory view showing a usage state of the bucket type jaw crusher.

FIG. 13 is an explanatory view showing another usage state of the bucket type jaw crusher.

FIG. 14 is an explanatory view showing still another usage state of the bucket type jaw crusher.

FIG. 15 is a view according to Embodiment 2, corresponding to FIG. 3.

FIG. 16 is a view according to Embodiment 3, corresponding to FIG. 3.

FIG. 17 is a view according to Embodiment 4, corresponding to FIG. 3.

FIG. 18 is a sectional view of a conventional bucket type jaw crusher.

FIG. 19 is a sectional view along line XIX-XIX of FIG. 18.

### DESCRIPTION OF THE PREFERRED EMBODIMENT

Hereinafter, a best mode for implementing the present invention will be described based on Embodiments.

### Embodiment 1

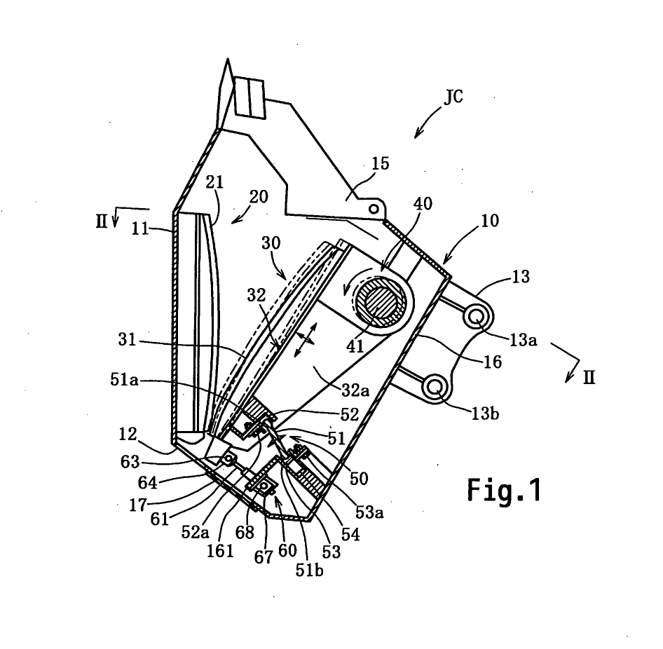

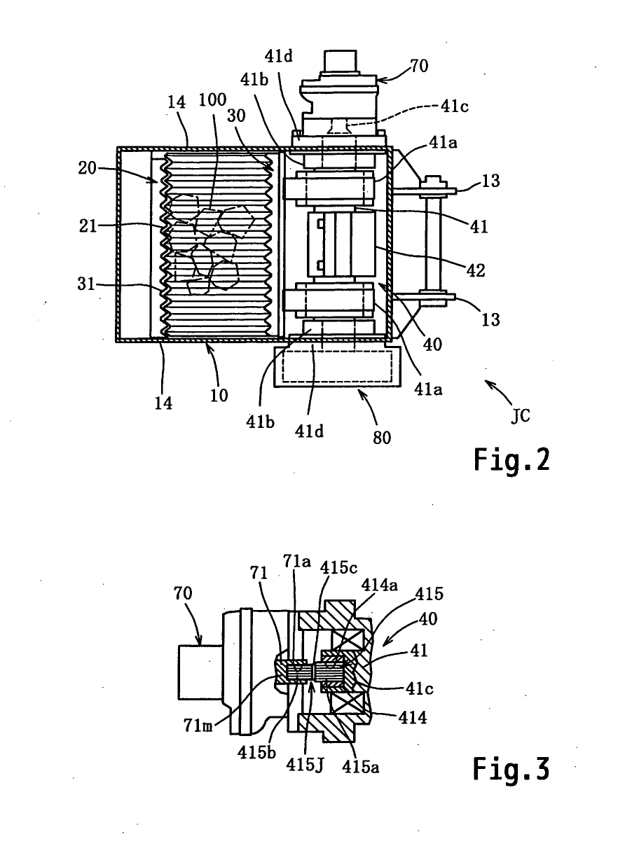

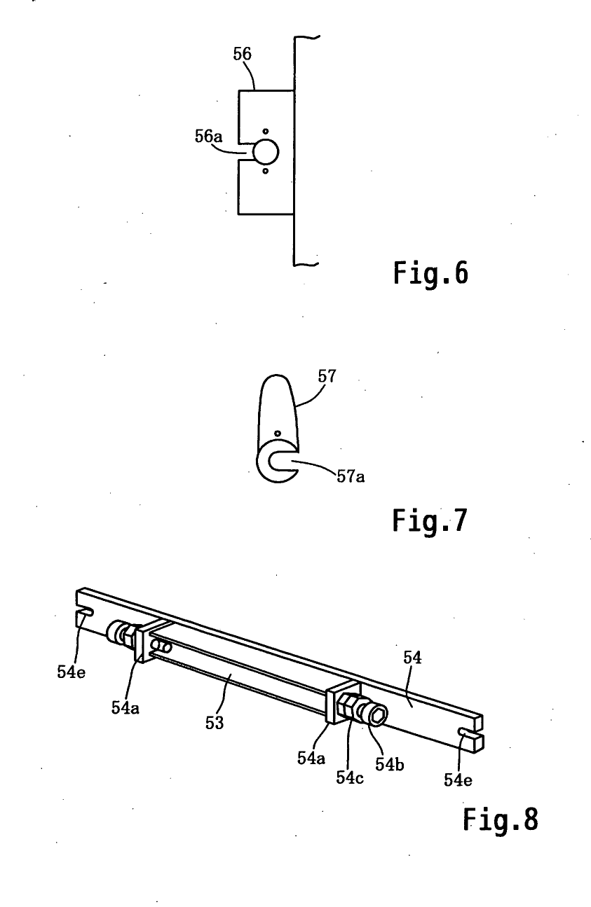

A bucket type jaw crusher JC according to Embodiment 1 will be described with reference to FIG. 1 to FIG. 14. As shown in FIG. 1 and FIG. 2, the bucket type jaw crusher JC includes stationary jaw teeth 20, movable jaw teeth 30, an eccentric main shaft unit 40, a toggle plate mechanism 50, and a tension device 60, etc. The bucket type jaw crusher JC presses an object 100 to be crushed against the stationary jaw teeth 20 to crush the object to be crushed by the movable jaw teeth 30 via rocking motion of a toggle plate 51 while reciprocating the movable jaw teeth 30 by forward rotation of the eccentric main shaft 41.

The stationary jaw teeth 20 include a plurality of wavy teeth 21 with mountains and valleys formed vertically in a gentle arc shape on the surface side, and are fixed to the inner surface of the side plate 11 of the bucket 10. The movable jaw teeth 30 include wavy teeth 31 with mountains and valleys formed vertically in a gentle arc shape on the surface side so as to engage with the wavy teeth 21 of the stationary jaw teeth 20. The wavy teeth 21 and 31 of the stationary jaw teeth 20 and the movable jaw teeth 30 have the same shape as viewed from above.

The upper portion of the movable jaw teeth 30 is axially supported by the eccentric main shaft 41 of the eccentric main shaft unit 40 via a pair of eccentric bearings 41a, and the lower portion of the movable jaw teeth 30 is supported on the toggle plate 51 via a movable jaw teeth side load receiving section 52. The movable jaw teeth 30 are opposed to the stationary jaw teeth 20 so as to form V shapes. The gripping angle between the movable jaw teeth 30 and the stationary jaw teeth 20 is set to be small not more than 7° to 8°.

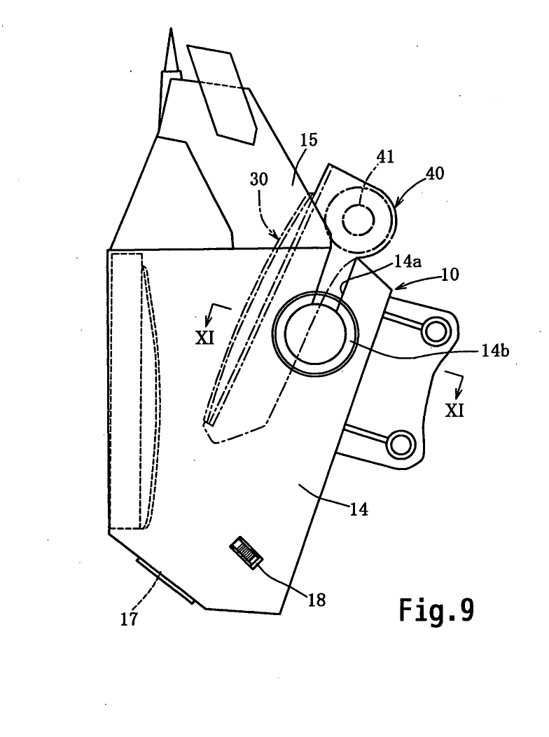

As shown in FIG. 1 and FIG. 2, the eccentric main shaft 41 penetrates through the pair of left and right side plates 14 of the bucket 10 and is driven to rotate by the hydraulic motor 70 as a rotational driving means. The hydraulic motor 70 is provided on the outside of one side plate 14, the hydraulic motor 70 is joined to one end portion of the eccentric main shaft 41, and to the other end of the eccentric main shaft 41 on the outside of the other side plate 14, a flywheel 80 is joined integrally. On both side plates 14 of the bucket 10, a pair of left and right U-shaped fitting grooves 14a opened to the bucket opening 15 side are formed (refer to FIG. 9). By using the fitting grooves 14a, the unitized eccentric main shaft unit 40 is fitted to the bucket 10.

As shown in FIG. 2, the eccentric main shaft 41 is equipped with a counterweight 42 for balance adjustment, integrally. The counterweight 42 is disposed at an intermediate position between the hydraulic motor 70 and the flywheel 80. The counterweight 42 is attached to the eccentric main shaft 41 so that the center of gravity of the counterweight 42 comes above the eccentric main shaft 41 on the opposite side of the movable jaw teeth 30 when the movable jaw teeth 30 descends in the reciprocating motion of the movable jaw teeth 30, and the center of gravity comes below the eccentric main shaft 40 on the movable jaw teeth 30 side when the movable jaw teeth 30 ascends. In this manner, the counterweight 42 balances the bucket 10 while canceling an inertial force generated due to rotational motion of the eccentric main shaft 41.

As shown in FIG. 3, a shaft joint mechanism 415J which joins the drive shaft 71 of the hydraulic motor 70 to the shaft end portion 41c of the eccentric main shaft 41 is provided, and the shaft joint mechanism 415J is provided with an allowable rupture portion 415c (i.e. allowed-to-rupture portion) which ruptures earlier than the main shaft portion 71m of the drive shaft 71 and the eccentric main shaft 41 when an abnormal overload is applied. To the shaft end portion 41c of the eccentric main shaft 41, a first sleeve 414 is fixed. The first sleeve 414 is disposed concentrically with the eccentric main shaft 41, and fitted and fixed into a cylindrical hole formed in the shaft end portion of the eccentric main shaft 41. At the inner periphery of the first sleeve 414, a first spline hole 414a is formed.

At the end portion of the main body shaft portion 71m of the drive shaft 71, a second spline hole 71a with a diameter smaller than that of the first spline hole 414a is formed, and in the spline holes 414a and 71a, the first spline shaft 415 is spline-engaged. The first spline shaft 415 includes a large-diameter shaft portion 415a spline-engaged in the first spline hole 414a, a small-diameter shaft portion 415b spline-engaged in the second spline hole 71a, and an annular groove with a small width formed at the boundary between the large-diameter shaft portion 415a and the small-diameter shaft portion 415b.

A small-diameter portion which is formed on the first spline shaft 415 via the annular groove and has a diameter smaller than the small-diameter shaft portion 415b constitutes the allowable rupture portion 415c. Thus, a driving force according to forward rotation and reverse rotation of the hydraulic motor 70 can be transmitted to the eccentric main shaft 41 via the first spline shaft 415. In addition, when an abnormal overload is applied to the first spline shaft 415, the allowable rupture portion 415c of the first spline shaft 415 ruptures earlier than the main body shaft portion 71m of the drive shaft 71 and the eccentric main shaft 41, so that the main body shaft portion 71m of the drive shaft 71 of the hydraulic motor 70 and the eccentric main shaft 41 can be reliably prevented from being broken.

As shown in FIG. 1, the toggle plate mechanism 50 includes the toggle plate 51, a movable teeth side load receiver 52, a stationary side load receiver 53, and adjusting plates 54, etc. On the toggle plate 51, an upper end load surface 51a and a lower end load surface 51b having convex partially cylindrical sectional shapes are formed on upper and lower end portions. The upper end load surface 51a is in contact with the movable teeth side load receiving section 52, and the lower end load surface 51b is in contact with the stationary side load receiving section 53.

The movable jaw teeth side load receiving section 52 has a lower surface having a recessed partially cylindrical shape, and an upper surface fixed to a member fixed to the lower end portion of the movable jaw teeth 30 via a fixture 52a. The bucket side load receiving section 53 has an upper surface having a recessed partially cylindrical shape, and a lower surface fixed to a member fixed to the side plate 16 of the bucket 10 sandwiching the adjusting plates 54 via a fixture 53a. By releasing the fixtures 52a and 53a, the toggle plate 51 can be removed. The movable jaw teeth side load receiving section 52 is disposed higher than the bucket side load receiving section 53.

The upper end load surface 51a of the toggle plate 51 comes into contact with the movable jaw teeth side load receiving section 52, and the lower end load surface 51b comes into contact with the bucket side load receiving section 53, and these contact portions are kept in a close contact state so as not to come off by the tension device 60 described later. The toggle plate 51 is attached to the movable jaw teeth 30 so as to have a rising gradient from a perpendicular surface perpendicular to the movable jaw teeth 30 to the eccentric main shaft 41 side. The movable jaw teeth 30 reciprocate up and down according to rotational motion of the eccentric main shaft 41, so that the movable jaw teeth are pressed against the stationary jaw teeth 20 while sandwiching the object 100 to be crushed via rocking motion of the toggle plate 51.

When the load receiving section 52 of the toggle plate 51 is worn, it can be component replaced by detaching the fixture 52a, and when the load receiving section 53 is worn, it can be component replaced by detaching the fixture 53a.

As shown in FIG. 5 to FIG. 8, both end portions of the adjusting plates 54 including a plurality of laminated band plates are supported on a pair of fixing plates 56. At both end portions of the adjusting plates 54, a pair of U-shaped bolt holes 54e whose openings are directed outward are formed, respectively. In the fixing plates 56, a pair of U-shaped bolt holes 56a whose openings are directed outward are also formed at positions corresponding to the bolt holes 541 of the adjusting plates 54. At the rocking members 57, a U-shaped notched groove 57a opened to one direction is formed.

Attaching bolts 55 are formed to be screw-fitted to nuts 55a, and are inserted through notched groove holes 57a, bolt holes 56a, and bolt holes 54e. The rocking members 57 are arranged turnable around the attaching bolts 55. Therefore, when the adjusting plates 54 are fixed, after the rocking members 57 are turned so that the openings of the notched grooves 57a are directed differently from the directions of the openings of the bolt holes 56a and the bolt holes 54e, the nuts 55a are tightened, and the adjusting plates 54 can be sandwiched between the fixing plates 56 and the nuts 55a.

When adjusting the number of adjusting plates 54 to increase or decrease, the nuts 55a are loosened and the rocking members 57 are turned so that the openings of the notched grooves 57a are directed to the same direction as the openings of the bolt holes 56a and the bolt holes 54e, and then the attaching bolts 55 are removed from the notched groove holes 57a, the bolt holes 56a, and the bolt holes 54e, and accordingly, the adjusting plates 54 can be attached and detached. By adjusting the number of adjusting plates 54 to increase or decrease, the gap between the lower end portion of the movable jaw teeth 30 and the lower end portion of the stationary jaw teeth 20 can be adjusted to increase or decrease, and the crushing size of the object 100 to be crushed can be adjusted.

As shown in FIG. 8, on the adjusting plates 54 for adjusting the crushing size, a pair of brackets 54a that support both ends of the stationary side load receiving section 53 are provided. To the brackets 54a, screw jacks 54b and 54c are fitted. The tip end portions of the screw jacks 54b and 54c are formed to have columnar shapes, and prevent the stationary side load receiving section 53 from coming off by supporting both end portions of the stationary side load receiving section 53.

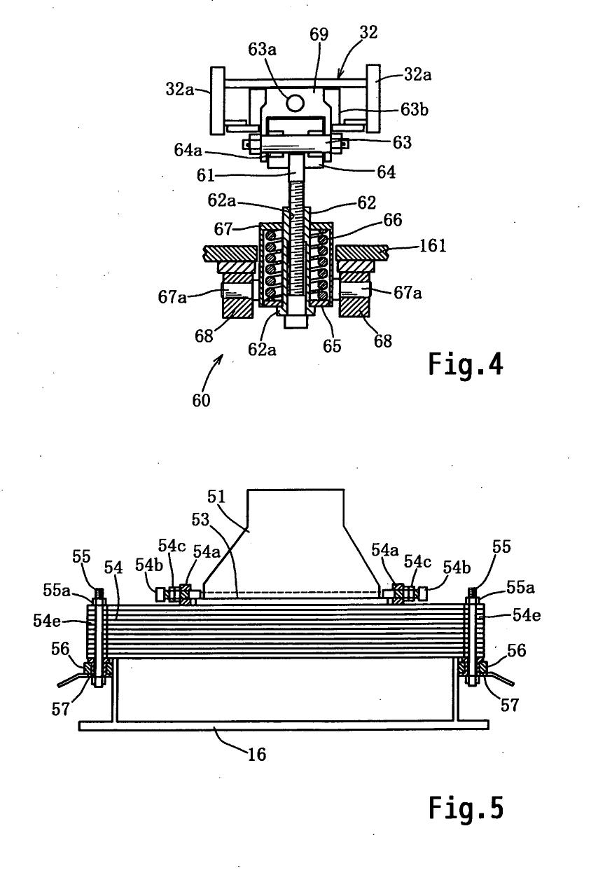

As shown in FIG. 4, the tension device 60 includes a tension rod 61, a receiving seat member 69, a compression spring 66, a pipe nut 62 (nut portion), etc. The tension rod 61 is disposed between a movable jaw teeth frame 32 reinforced by a pair of reinforcing ribs 32a and a support plate 161 jutting from the side plate 16 of the bucket 10. On the outer periphery of the tension rod 61, a male threaded portion is formed.

The receiving seat member 69 is pivotally supported rotatably on a bearing stand 63b provided on the movable jaw teeth frame 32 via a pin 63a. The receiving seat member 69 pivotally supports a turning bearing portion 64 turnable on the support plate 161 side via a pin 63. The lower portion of the turning bearing portion 64 is joined to the upper portion of the tension rod 61. The tension rod 61 is formed turnable in a direction parallel to a plane orthogonal to the pin 63 by using the pin 63 as a rotary shaft. The receiving seat member 69 receives an input of a load applied to the turning bearing portion 64 of the tension rod 61 from the pin 63, and transmits the load to the bearing stand 63b from the pin 63a.

The compression spring 66 is housed inside a cylindrical spring case 67.

The spring case 67 has a circular opening at the central portion of the upper end wall. On both outer sides of the spring case 67, a pair of pins 67a disposed in a direction parallel to the pin 63 are provided and pivotally supported on a bearing member 68 turnably. The bearing member 68 is fixed to the support plate 161 jutting from the side plate 16 of the bucket 10.

A pipe nut 62 is formed to have a cylindrical shape so as to be inserted through the opening of the upper end wall of the spring case 67. On the lower end portion of the pipe nut 62, a flange portion 62a jutting to the outer peripheral side is formed. An annular seat plate 65 is latched on the flange portion 62a formed on the lower end portion of the pipe nut 62.

The compression spring 66 is disposed inside the spring case 67 while being sheathed by the pipe nut 62. The upper end of the compression spring 66 is received by the upper end wall of the spring case 67, and the lower end of the compression spring 66 is received by the seat plate 65. On the inner periphery of the upper side portion of the pipe nut 62, a female threaded portion to which the male threaded portion of the lower portion of the tension rod 61 is screw-fitted is formed.

Accordingly, an increase and decrease in inclination of the tension rod 61 according to reciprocating motion of the movable jaw teeth 30 and an increase and decrease in inclination of the tension rod 61 according to an increase and decrease in the size adjusting plates 54 can be followed by turning of the pin 63 of the turning bearing portion 64, turning of the pin 67a of the spring case 67, turning of the pin 63a, and by the flexure of the compression spring 66. Therefore, by an elastic urging force of the compression spring 66, a close contact state can be always kept between the upper end load surface 51a of the toggle plate 51 and the load receiving section 52 and between the lower end load surface 51b and the load receiving section 53.

Next, a fitting order of the eccentric main shaft unit 40 will be described.

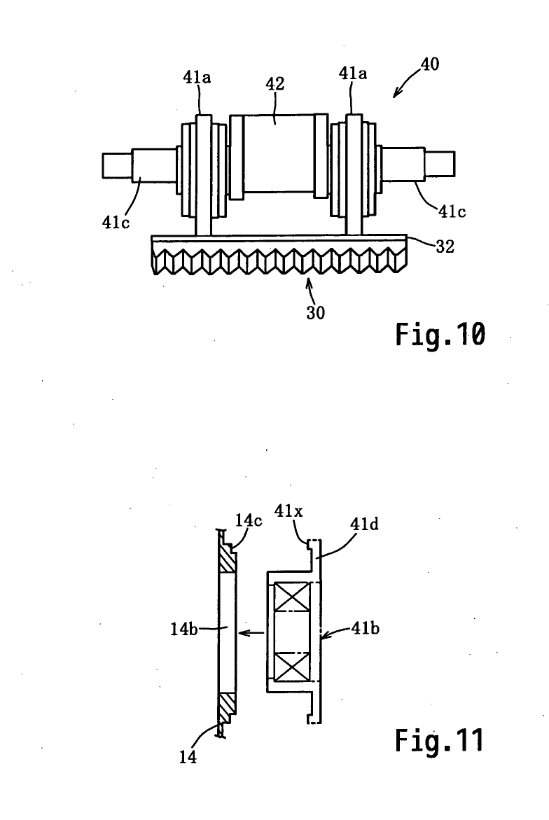

As shown in FIG. 10, when the eccentric main shaft 41 and the movable jaw teeth 30 are fitted into the bucket 10, they are unitized into the eccentric main shaft unit 40 in advance by attaching the counterweight 42 integrally to the intermediate portion of the eccentric main shaft 41, and fitting the movable jaw teeth frame 32 and the movable jaw teeth 30, etc., via the pair of eccentric bearings 41a attached to the left and right sides of the counterweight 42.

As shown in FIG. 9 and FIG. 11, both shaft ends of the eccentric main shaft 41 of the eccentric main shaft unit 40 are moved to both main shaft receiving portions 14b along the pair of fitting grooves 14a. Both shaft ends 41c of the eccentric main shaft 41 are inserted in the main shaft receiving portions 14b, and a fitting portion 41x of the main shaft receiving portion 41b is fitted to a fitting portion 14c of the shaft portion 41b. Accordingly, the eccentric main shaft unit 40 can be quickly fitted into the bucket 10 and positioned with a high degree of precision.

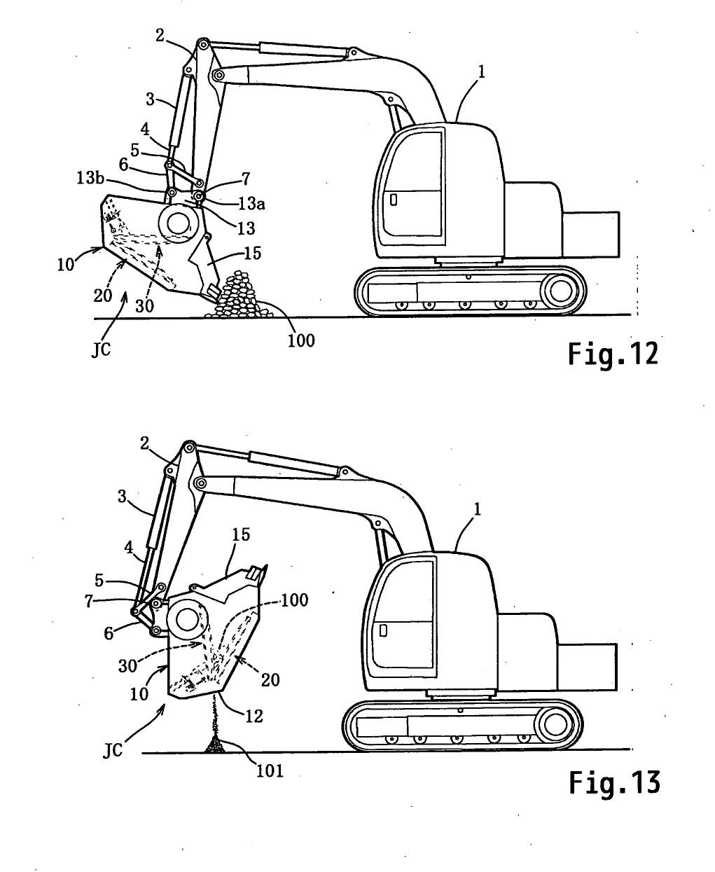

Next, a usage pattern of the bucket type jaw crusher JC will be described based on FIG. 12 to FIG. 14. As shown in FIG. 12, the shaft hole 13a of the bracket 13 of the bucket 10 is axially supported on a pinhole 7 at the tip end of the arm 2 of a hydraulic shovel 1, and the other shaft hole 13b is axially supported on a rod 4 of a bucket cylinder 3 via H-shaped links 5 and 6. First, the opening 15 of the bucket 10 is disposed so as to oppose the object 100 to be crushed, and the bucket cylinder 3 is operated to scoop the object 100 to be crushed into the inside of the bucket 10.

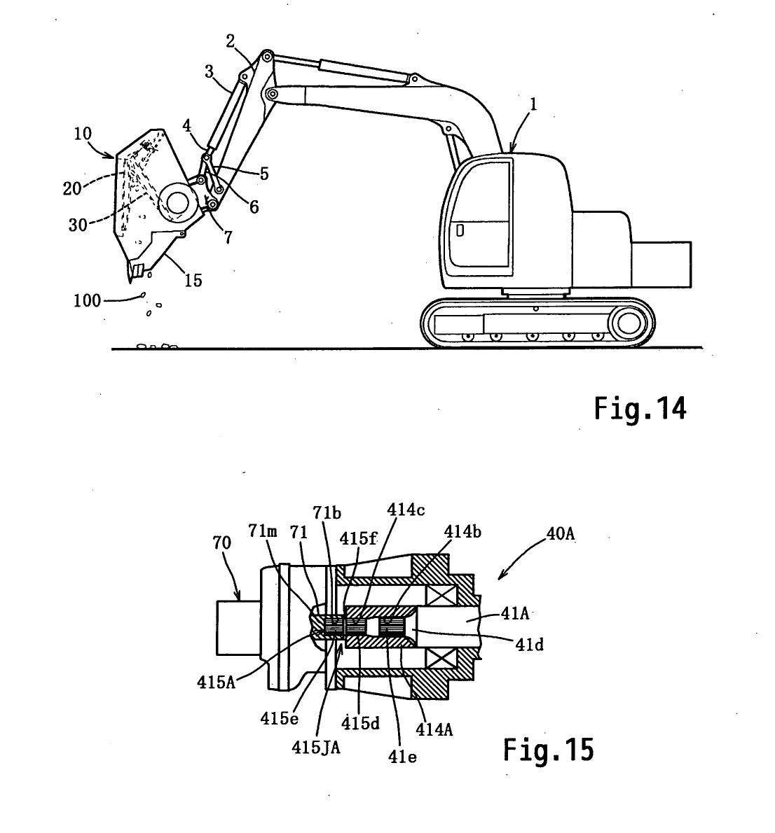

Next, as shown in FIG. 13, the bucket cylinder 3 is operated so that the opening 15 of the bucket 10 is directed upward, and the hydraulic shovel 1 is moved to a location where objects 100 to be crushed are accumulated. Next, the hydraulic motor 70 is driven to actuate the movable jaw teeth 30 and crush the object 100 to be crushed into crushed pieces 101, and discharges the crushed pieces from the discharge opening 12 formed at the lower end of the bucket 10. On the other hand, as shown in FIG. 14, when the object 100 to be crushed clogs the space between the movable jaw teeth 30 and the stationary teeth 20, the opening 15 of the bucket is directed downward and the hydraulic motor 70 is rotated reversely to enlarge the space between the movable jaw teeth 30 and the stationary teeth 20, and accordingly, the object 100 to be crushed can be removed from the space between the movable jaw teeth 30 and the stationary teeth 20.

Next, the advantage of the bucket type jaw crusher JC will be described.

In this jaw crusher JC, the shaft joint mechanism 415J which joins the drive shaft 71 of the hydraulic motor 70 to the shaft end portion 41c of the eccentric main shaft 41 is provided, and this shaft joint mechanism 415J is provided with an allowable rupture portion 415c which ruptures earlier than the main body shaft portion 71m of the drive shaft 71 and the eccentric main shaft 41 when an abnormal overload is applied, so that even when the allowable rupture portion 415c of the first spline shaft 415 is broken by an abnormal overload, without requiring replacement of the eccentric main shaft 41 including the flywheel 80 and the counterweight 42 fitted integrally and replacement of the hydraulic motor 70, repair can be performed easily and inexpensively by replacement of the spline shaft 415. The spline shaft 415 can be downsized, and the structure can be simplified. Further, the spline shaft 415 can be easily replaced, so that when the hydraulic motor 70 is replaced, it can also be easily and efficiently replaced.

### Embodiment 2

Next, a bucket type jaw crusher JC according to Embodiment 2 will be described with reference to FIG. 15. Members identical to those in Embodiment 1 are provided with the same reference numerals.

A shaft joint mechanism 415JA which joins the drive shaft 71 of the hydraulić motor 70 in the eccentric main shaft unit 40A to the end portion of the eccentric main shaft 41A is provided, and this shaft joint mechanism 415JA is provided with an allowable rupture portion 415f which ruptures earlier than the main body shaft portion 71m of the drive shaft 71 and the eccentric main shaft 41A when an abnormal overload is applied.

This shaft joint mechanism 415JA includes a second sleeve 414A for joining the drive shaft 71 and the eccentric main shaft 41A, third and fourth spline holes 414b and 414c formed in this second sleeve 414A, a fifth spline hole 71b formed in the shaft end portion of the main body shaft portion 71m of the drive shaft 71, a first spline shaft portion 41e formed on the shaft end portion of the eccentric main shaft 41A via a tapered portion 41d and spline-engaged in the third spline hole 414b, and a second spline shaft 415A spline-engaged in the fourth and fifth spline holes 414c and 71b.

The third spline hole 414b has a diameter larger than that of the fourth spline hole 414c. The fourth and fifth spline holes 414c and 71b are formed to have inner diameters equal to each other, and the outer diameter of the second sleeve 414A is formed to be equal to the outer diameter of the eccentric main shaft 41A. The allowable rupture portion 415f is formed by a small-diameter portion which is formed via an annular groove formed on the second spline shaft 415A between the fourth and fifth spline holes 414c and 71b and has a diameter smaller than that of the spline shaft portion of the second spline shaft 415A. An operation and advantage of the shaft joint mechanism 415JA are basically the same as those in Embodiment 1.

### Embodiment 3

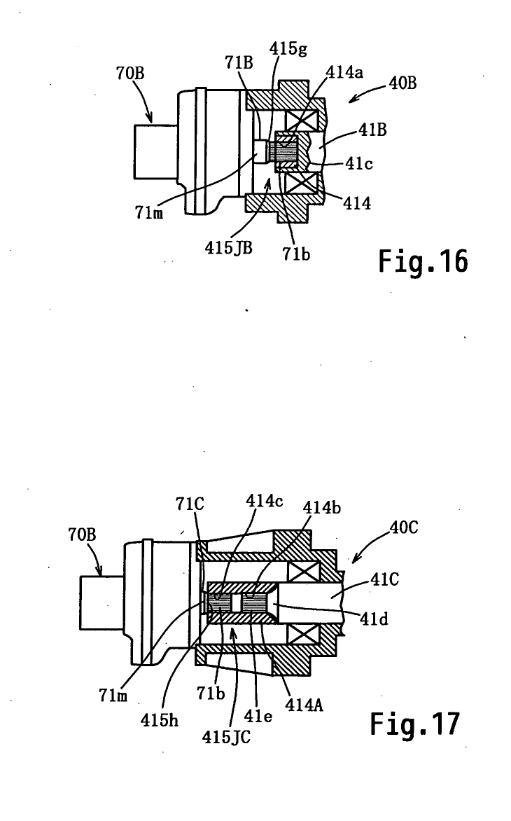

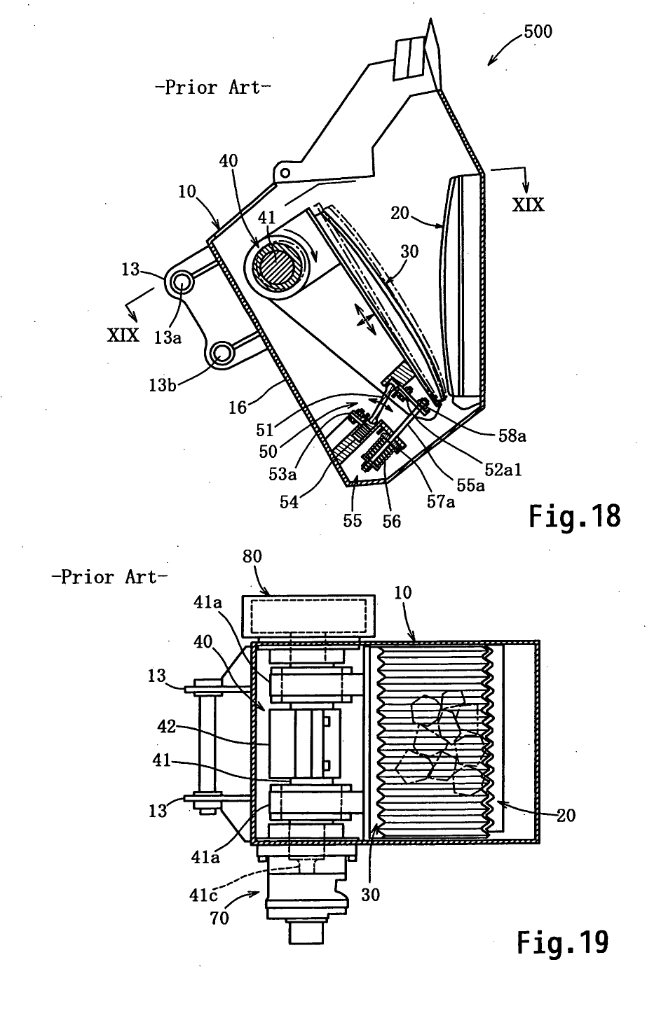

Next, a bucket type jaw crusher JC according to Embodiment 3 will be described with reference to FIG. 16. Members identical to those in Embodiment 1 are provided with the same reference numerals.

A shaft joint mechanism 415JB which joins the drive shaft 71B of the hydraulic motor 70B in the eccentric main shaft unit 40B to the end portion of the eccentric main shaft 41B is provided, and this shaft joint mechanism 415JB is provided with an allowable rupture portion 415g which ruptures earlier than the main body shaft portion 71m of the drive shaft 71B and the eccentric main shaft 41B when an abnormal overload is applied.

The shaft joint mechanism 415JB includes a third sleeve 414 which is fitted and fixed inside the end portion of the eccentric main shaft 41B, a sixth spline hole 414a formed in the third sleeve 414, and a second spline shaft portion 71b extending from the main body shaft portion 71m of the drive shaft 71B and having a diameter smaller than that of the main body shaft portion 71m, and the allowable rupture portion 415g is formed by a portion of the second spline shaft portion 71b (specifically, a section discontinuous portion at the boundary between the main body shaft portion 71m and the second spline shaft portion 71b). In the case of this shaft joint mechanism 415JB, when the allowable rupture portion 415g ruptures due to an abnormal overload, the drive shaft 71B of the hydraulic motor 70B needs to be replaced, however, the eccentric main shaft 41B does not need to be replaced. Other operations and effects are basically the same as those in Embodiment 1.

### Embodiment 4

Next, a bucket type jaw crusher JC according to Embodiment 4 will be described with reference to FIG. 17. Members identical to those in Embodiments 1 and 2 are provided with the same reference numerals.

A shaft joint mechanism 415JC which joins the drive shaft 71C of the hydraulic motor 70B of the eccentric main shaft unit 40C to the end portion of the eccentric main shaft 41C is provided, and this shaft joint mechanism 415JC is provided with an allowable rupture portion 415h which ruptures earlier than the main body shaft portion 71m of the drive shaft 71C and the eccentric main shaft 41C when an abnormal overload is applied.

The shaft joint mechanism 415JC includes a fourth sleeve 414A for joining the drive shaft 71C and the eccentric main shaft 41C, seventh and eighth spline holes 414b and 414c formed in the fourth sleeve 414A, a third spline shaft portion 41e formed on the shaft end portion of the eccentric main shaft 41C and spline-engaged in the seventh spline hole 414b, and a fourth spline shaft portion 71b (with a diameter smaller than that of the main body shaft portion 71m) extending from the main body shaft portion 71m of the drive shaft 71C and spline-engaged in the eighth spline hole 414c, and the allowable rupture portion 415h is formed by a portion of the fourth spline shaft portion 71b (specifically, a section discontinuous portion at the boundary between the main body shaft portion 71m and the fourth spline shaft portion 71b).

In the case of this shaft joint mechanism 415JC, when the allowable rupture portion 415h ruptures due to an abnormal overload, the drive shaft 71C of the hydraulic motor 70B needs to be replaced, however, the eccentric main shaft 41C does not need to be replaced. Other operations and advantages are basically the same as those in Embodiment 1.

### DESCRIPTION OF REFERENCE NUMERALS

1 hydraulic shovel
2 arm
10 bucket
20 stationary jaw teeth
30 movable jaw teeth
40, 40A to 40C eccentric main shaft unit
41, 41A to 41C eccentric main shaft
51 toggle plate
52, 53 load receiving section
54 adjusting plate
54e, 56a u-shaped bolt hole
54a bracket
55 attaching bolt
56 fixing plate
57 rocking member
57a notched groove
60 tension device
61 tension rod
62 pipe nut
64 turning bearing portion
66 compression spring
69 receiving seat member
70, 70B hydraulic motor
71, 71B, 71C drive shaft
71a spline hole
71b spline shaft portion
100 object to be crushed
414, 414A sleeve
414a to 414c spline hole
415, 415A spline shaft
415c, 415f, 415g, 415h allowable rupture portion
415J, 415JA to 415JC shaft joint mechanism
JC jaw crusher

What is claimed is:

1. A bucket type jaw crusher attachable to an arm of a hydraulic shovel, comprising: stationary jaw teeth fixed to the inner surface of a bottom portion of a bucket; movable jaw teeth opposed to the stationary jaw teeth so as to form V shapes in combination with the stationary jaw teeth; a toggle plate supporting a lower portion of the movable jaw teeth, an eccentric main shaft axially supporting an upper portion of the movable jaw teeth; and a rotational driving means for driving and rotating the eccentric main shaft, and capable of crushing an object to be crushed by the movable jaw teeth that are driven to reciprocate by the rotational driving means via the eccentric main shaft and the stationary jaw teeth, wherein
a shaft joint mechanism which joins a drive shaft of the rotational driving means to an end portion of the eccentric main shaft is provided, and
the shaft joint mechanism is provided with an allowable rupture portion which ruptures earlier than a main body shaft portion of the drive shaft and the eccentric main shaft when an abnormal overload is applied.

2. The bucket type jaw crusher according to claim 1, wherein the shaft joint mechanism includes a first sleeve fitted and fixed inside an end portion of the eccentric main shaft; a first spline hole formed in the first sleeve; a second spline hole formed in an end portion of a main body shaft portion of the drive shaft; and a first spline shaft spline-engaged in the first and second spline holes, wherein the allowable rupture portion is formed by a small-diameter portion formed on the first spline shaft.

3. The bucket type jaw crusher according to claim 1, wherein the shaft joint mechanism includes a second sleeve for joining the drive shaft and the eccentric main shaft, third and fourth spline holes formed in the second sleeve, a fifth spline hole formed in an end portion of the drive shaft; a first spline shaft portion spline-engaged in the third spline hole formed in the end portion of the eccentric main shaft; and a second spline shaft spline-engaged in the fourth and fifth spline holes, wherein the allowable rupture portion is formed by a small-diameter portion formed on the second spline shaft.

4. The bucket type jaw crusher according to claim 1, wherein the shaft joint mechanism includes a third sleeve fitted and fixed inside an end portion of the eccentric main shaft; a sixth spline hole formed in the third sleeve; and a second spline shaft portion extending from a main body shaft portion of the drive shaft, wherein the allowable rupture portion is formed by a portion of the second spline shaft portion.

5. The bucket type jaw crusher according to claim 1, wherein
the shaft joint mechanism includes a fourth sleeve for joining the drive shaft and the eccentric main shaft; seventh and eighth spline holes formed in the fourth sleeve; and a third spline shaft portion spline-engaged in the seventh spline hole formed in the end portion of the eccentric main shaft; and a fourth spline shaft portion extending from a main body shaft portion of the drive shaft and spline-engaged in the eighth spline hole, wherein
the allowable rupture portion is formed by a portion of the fourth spline shaft portion.

6. The bucket type jaw crusher according to claim 1, wherein
a tension device is provided which elastically urges a movable teeth side load receiving section and a stationary side load receiving section of the toggle plate to load surface sides on both upper and lower ends of the toggle plate, respectively, and
the tension device includes a tension rod which supports turnably the movable jaw teeth via a turning bearing portion; a receiving seat portion which is supported on the movable jaw teeth and supports a load from the turning bearing portion; a compression spring which urges the tension rod; and a nut portion which latches the compression spring and to which the tension rod can be screw-fitted.

7. The bucket type jaw crusher according to claim 6, comprising:
fixing plates having U-shaped bolt holes;
one or a plurality of adjusting plates which have U-shaped bolt holes at positions corresponding to the bolt holes of the fixing plates, and can adjust the interval between the lower end portion of the stationary jaw teeth and the lower end portion of the movable jaw teeth;
a rocking member having notched grooves through which the bolts can be inserted; and
bolts which can be inserted through the bolt holes of the fixing plates, the bolt holes of the adjusting plate, and notched grooves of the rocking member, wherein
the rocking member is formed to be turnable around the bolts so that the openings of the notched grooves are directed toward the same direction as that of the openings of the bolt holes of the fixing plates and the bolt holes of the adjusting plate when the adjusting plate is attached or detached.

8. The bucket type jaw crusher according to claim 7, wherein the adjusting plate includes a bracket which can support both end portions of the stationary side load receiving section.

9. The bucket type jaw crusher according to claim 1, wherein a pair of fitting grooves through which the eccentric main shaft can pass from the bucket opening side are formed on both side plates of the bucket.
